(19) United States
(12) Patent Application Publication
(10) Pub. No.: US 2006/0238644 A1
(43) Pub. Date: Oct. 26, 2006

(54) Image capturing device having zoom control unit

(75) Inventor: Dong Seok Lee, Seoul (KR)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: Samsung Electronics Co., Ltd.

(21) Appl. No.: 11/336,883

(22) Filed: Jan. 23, 2006

(30) Foreign Application Priority Data
Apr. 21, 2005 (KR) 2005-33351

(51) Int. Cl. H04N 5/225

(52) U.S. Cl. 348/373

(57) ABSTRACT

An image capturing device including a zoom control unit with a variable zoom speed feature. The image capturing device includes a case having a manipulation hole, a holder provided inside the case, a knob, a plurality of quantum tunnelling composites (QTCs) housed in the holder, and a PCB. The knob is rotatably supported by the holder while having a portion exposed through the manipulation hole. Resistance of the QTC changes according to pressure applied from the knob. A plurality of current detectors is mounted on the PCB to detect current flowing through the QTCs. Voltage is applied across positive and negative electrodes formed on each QTC. No current flows through the QTC when no pressure is applied, and its resistance gradually decreases and current flowing therethrough gradually increases as pressure is applied. Each current detector detects the current and changes zoom speed in multiple steps according to the detected current.

### CROSS-REFERENCE TO RELATED APPLICATION

This application claims the benefit under 35 U.S.C.§ 119(a) of Korean Patent Application No. 2005-33351, filed Apr. 21, 2005, in the Korean Intellectual Property Office, the entire disclosure of which is hereby incorporated by reference.

### BACKGROUND OF THE INVENTION

1. Field of the Invention

The present invention relates to an image capturing device having a zoom control unit. More particularly, the present invention relates to an image capturing device having a zoom control unit with a variable zoom speed feature.

2. Description of the Related Art

General image capturing devices such as digital cameras or camcorders have features to capture, record, and reproduce still or moving images.

Such image capturing devices typically include a zoom lens module capable of zooming in on a distant subject. Such devices also include a zoom control unit having a zoom function (that is, a tele/wide (T/W) function). Some recently introduced image capturing devices have a zoom control unit with a variable zoom speed feature.

One example of a zoom control unit is shown in FIG. 1. This zoom control unit 1 comprises a zoom knob 3 slidably mounted on a case 2 of an image capturing device, first and second compression springs 4 and 5 to return the position of the zoom knob 3 to an initial position A0, and a zoom switch 6 that operates in conjunction with the zoom knob 3. If the user pushes or pulls the zoom knob 3 with their finger in order to activate the zoom function, the zoom knob 3 moves from the initial position A0 to a T position A1 or to a W position A2, where the initial position A0 is located in the middle of the T and W positions A1 and A2, and the T and W positions A1 and A2 are located on the left and right, respectively. When the zoom knob 3 moves to the T position A1 or to the W position A2, the zoom speed may change stepwise, for example, from a first speed to a second speed, depending on how far the zoom knob 3 has moved from the initial position A0.

If the force applied to move the zoom knob 3 to the T position A1 or the W position A2 is released, the first and second compression springs 4 and 5, which have elasticity to push the zoom knob 3 in opposite directions, return the zoom knob 3 to the initial position A0.

In this manner, the zoom control unit 1 uses the compression springs 4 and 5 to return the zoom knob 3 to the initial position A0. However, if the forces of the first and second springs 4 and 5 to push the zoom knob 3 become unbalanced, the zoom knob 3 is not located at the initial position A0, deviating to the T or W position A1 or A2. This may automatically cause zooming without intentionally activating the zoom control unit 1.

It is also difficult to reduce the size of the image capturing device since it uses the springs 4 and 5 and the large-volume switch 6.

Further, the force applied to push or pull the zoom knob 3 to activate the zoom control unit 1 may be transferred to the body of the image capturing device, thereby shaking the screen when capturing an image.

Accordingly, there is a need for an improved image capturing device with an improved zoom control unit.

### SUMMARY OF THE INVENTION

An aspect of the present invention is to address at least the above problems and/or disadvantages and to provide at least the advantages described below. Accordingly, an aspect of the present invention is to provide an image capturing device having a zoom control unit which has a low risk of malfunction.

It is another aspect of the invention to provide an image capturing device having a simple, small zoom control unit, thereby producing a compact and inexpensive image capturing device.

It is yet another aspect of the invention to provide an image capturing device having a zoom control unit that minimizes shaking of the image capturing device when the zoom control unit is manipulated, thereby reducing screen shaking when capturing an image.

Additional aspects and/or advantages of the invention will be set forth in part in the description which follows and, in part, will be obvious from the description, or may be learned by practice of the invention.

In accordance with an aspect of the invention, an image capturing device having a zoom control unit comprises a case having a manipulation hole, a holder provided inside the case, a knob rotatably supported by the holder while having a portion exposed through the manipulation hole, a plurality of quantum tunnelling composites (QTCs) housed in the holder, and a printed circuit board (PCB) including a plurality of current detectors. The resistance of each of the QTCs changes according to pressure applied from the knob, and the current detectors on the PCB detect the current flowing through the plurality of QTCs.

Voltage may be applied across positive and negative electrodes formed on each of the QTCs.

A QTC may be configured so that no current flows through it when no pressure is applied to the QTC, and so that the resistance of the QTC gradually decreases and current flowing through the QTC gradually increases as pressure is applied to the QTC.

Each of the current detectors may detect current flowing through a corresponding one of the QTCs and may change zoom speed in multiple steps according to the detected current.

Each of the QTCs may have elasticity such that the QTC is restored to an original state when the pressure applied to the QTC is released.

A tele (T) operating portion to activate a T mode and a wide (W) operating portion to activate a W mode may be provided on an upper surface of the knob, and a rotating shaft may be integrally formed on the center of a lower surface of the knob so that the knob is rotatable.

An end portion of a first one of the QTCs, which receives pressure when the T operating portion is pressed, may be placed in a first receiving groove formed on the lower surface of the knob, and an end portion of a second one of the QTCs, which receives pressure when the W operating portion is pressed, may be placed in a second receiving groove formed on the lower surface of the knob.

A first rotating shaft receiving portion may be formed at the center of the holder to receive the rotating shaft so that the rotating shaft is rotatably supported by the first rotating shaft receiving portion, and first and second receiving holes to respectively receive the first and second QTCs may be formed on the holder about the first rotating shaft receiving portion.

The case may include a plurality of bosses formed thereon, each protruding down from the case to be coupled to the PCB and having a threaded hole defined therein. A second rotating shaft receiving portion may be formed on the case, the second rotating shaft receiving portion being combined with the first rotating shaft receiving portion to prevent separation of the rotating shaft.

In accordance with another aspect of the invention, an image capturing device having a zoom control unit comprises a case having a manipulation hole, a holder provided inside the case, a knob rotatably supported by the holder while having a portion exposed through the manipulation hole, first and second quantum tunnelling composites (QTCs), and first and second current detectors. The resistances of the first and second quantum tunnelling composites vary, respectively, according to changes of pressure applied to tele (T) and wide (W) operating portions provided on an upper portion of the knob. The first and second current detectors are connected respectively to the first and second QTCs, to detect current flowing through the first and second QTCs and to change zoom speed according to the detected current.

### BRIEF DESCRIPTION OF THE DRAWINGS

The above and other objects, features, and advantages of certain embodiments of the present invention will be more apparent from the following description taken in conjunction with the accompanying drawings, in which:

FIG. 1 is a sectional view of a conventional zoom control unit;

FIG. 2 is a perspective view of an image capturing device having a zoom control unit according to an exemplary embodiment of the present invention;

FIG. 3 is an exploded perspective view of a zoom control unit according to an exemplary embodiment of the present invention;

FIG. 4 is a sectional view of an assembled zoom control unit according to an exemplary embodiment of the present invention;

FIG. 5 is a graph illustrating the relationship between the force applied to a QTC, which is used in the zoom control unit according to an exemplary embodiment of the present invention, and the logarithm of its resistance; and

FIGS. 6 and 7 are schematic diagrams illustrating the difference between a QTC before and after pressure is applied.

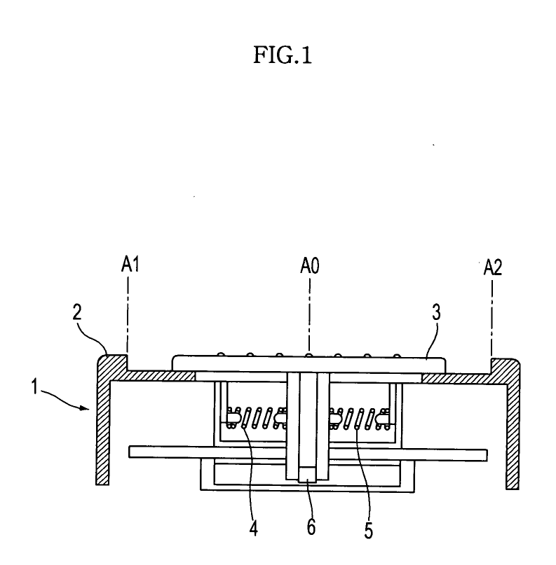

Throughout the drawings, the same drawing reference numerals will be understood to refer to the same elements, features, and structures.

### DETAILED DESCRIPTION OF EXEMPLARY EMBODIMENTS

The matters defined in the description such as a detailed construction and elements are provided to assist in a comprehensive understanding of the embodiments of the invention. Accordingly, those of ordinary skill in the art will recognize that various changes and modifications of the embodiments described herein can be made without departing from the scope and spirit of the invention. Also, descriptions of well-known functions and constructions are omitted for clarity and conciseness.

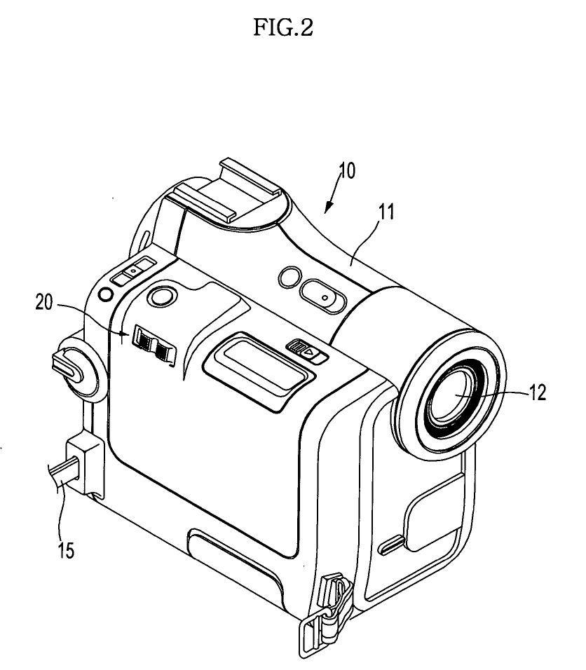

An image capturing device having a zoom control unit according to an exemplary embodiment of the present invention will now be described in detail with reference to FIGS. 2 to 7.

As shown in FIG. 2, an image capturing device 10 comprises a case 11 defining the exterior of the image capturing device 10, a lens located at a front portion of the case 11 to focus a subject image, a display unit (not shown) to display the subject image received through the lens 12, and a variety of switches (not shown) to activate a variety of functions. A handstrap is provided on the right of the case 11 to allow the user to firmly grasp the image capturing device 10 with one hand such that the user operates the switches while grasping the image capturing device 10 with the hand. A zoom control unit 20 is also provided on the right of the case 11 to enable the user to activate a zoom lens module (not shown), which is provided to zoom in on a distant subject, using fingers inserted in the handstrap 25. Manipulating the zoom control unit 20 activates a motor provided in the case 11. The rotational force of the motor is transferred to a gear of a zoom-lens rotation tube to rotate the zoom-lens rotating tube, thereby carrying out a zoom operation.

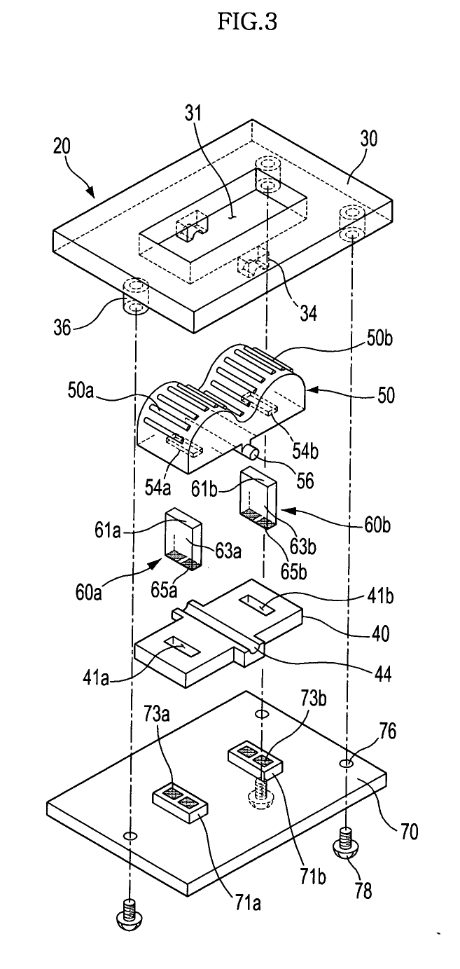

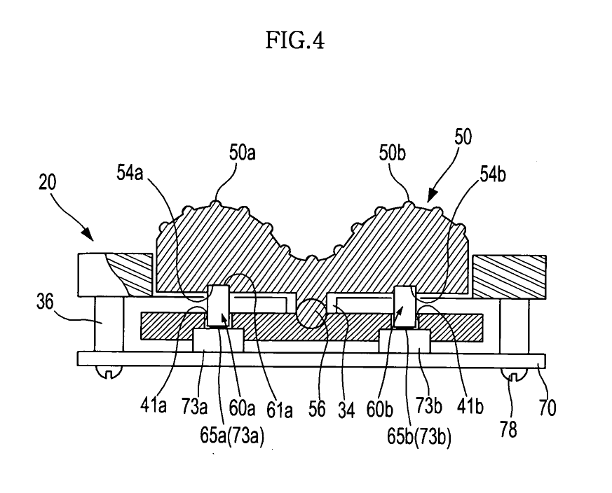

As shown in FIGS. 3 and 4, the zoom control unit 20 to control the zoom operation of the image capturing device 10 comprises a case 30 having a manipulation hole 31, a holder 40 provided inside the case 30, a knob 50 which is rotatably supported by the holder 40 while having a portion exposed through the manipulation hole 31, two quantum tunnelling composites (QTCs) 60a and 60b, the resistance of each of which changes according to pressure applied from the knob 50, and a printed circuit board (PCB) 70 on which a microcomputer (not shown) and a variety of parts including two current detectors 71a and 71b to respectively detect current flowing through the two QTCs 60a and 60b are mounted. A description of the QTC will be given after the description of the configuration of the zoom control unit 20.

A tele (T) operating portion 50a and a wide (W) operating portion 50b are provided on an upper surface of the knob 50 to activate a T mode and a W mode. A rotating shaft 56, which rotates as the T operating portion 50a or the W operating portion 50b is pressed, is formed on the center of a lower surface of the knob 50 so that the rotating shaft 56 is integrated with the knob 50. A first receiving groove 54a and a second receiving groove 54b, which receive respective tops 61a and 61b of the QTCs 60a and 60b, are formed symmetrically with respect to the rotating shaft 56. That is, the top 61a of the first QTC 60a, which receives pressure when the T operating portion 50a is pressed down, is received in the first receiving groove 54a, and the top 61b of the second QTC 60b, which receives pressure when the W operating portion 50b is pressed down, is received in the second receiving groove 54b.

A first rotating shaft receiving portion 44 is defined in the center of an upper surface of the holder 40 provided under the knob 50 to receive the rotating shaft 56 integrated with the knob 50 so that the rotating shaft 56 is rotatably supported on the first rotating shaft receiving portion 44. First and second receiving holes 41a and 41b are also defined in the holder 40 to respectively receive the first and second QTCs 60a and 60b while supporting sides 63a and 63b of the two QTCs 60a and 60b so as to prevent the two QTCs 60a and 60b from being bent when they are pressed by the knob 50. Here, it is preferable that the first and second receiving holes 41a and 41b are symmetrical with respect to the first rotating shaft receiving portion 44 so that the first and second QTCs 60a and 60b receive the same pressure from the T and W operating portions 50a and 50b provided on the upper portion of the knob 50 when the T and W operating portions 50a and 50b are pressed with the same force.

Various circuit components are mounted on the PCB 70 provided under the holder 40. The first and second current detectors 71a and 71b, which are provided on the PCB 70, are in contact respectively with the first and second QTCs 60a and 60b to detect the amount of current flowing through the first and second QTCs 60a and 60b and change the zoom speed in multiple steps (that is, in a stepwise fashion) according to the detected amount of current. A terminal 73a provided on the first current detector 71a is in contact with a terminal 65a provided on the bottom of the first QTC 60a, and a terminal 73b provided on the second current detector 71b is in contact with a terminal 65b provided on the bottom of the second QTC 60b. Each of the terminals 73a and 73b is divided into positive (+) and negative (−) poles across which a specific voltage is applied. The specific voltage is also applied to each of the terminals 65a and 65b of the first and second QTCs 60a and 60b since the terminals 65a and 65b thereof are in contact respectively with the terminals 73a and 73b of the first and second current detectors 71a and 71b.

A plurality of bosses 36 is provided on the case 30 that is provided at the top of the zoom control unit and defines the exterior thereof. Each of the bosses 36 has a threaded hole defined therein and protrudes down from the case 30 so as to be coupled to the PCB 70. A second rotating shaft receiving portion 34 is also provided on the case 30. The second rotating shaft receiving portion 34 is combined with the first rotating shaft receiving portion 44 to prevent separation of the rotating shaft 56 formed on the knob 50. After the bosses 36 are aligned with a plurality of screw insertion holes 76 defined in the PCB 70, the bosses 36 are secured to the screw threaded holes 76 with screws, thereby completing the assembly of the zoom control unit 20.

A description will now be given of QTCs 60a and 60b which receive pressure from the knob 50. The Quantum Tunnelling Composite (QTC) is material which exhibits a change in resistance as pressure is applied. QTC is available from Peratech, Ltd., of Darlington, U.K. Further details regarding QTC are described in U.S. Pat. No. 6,495,069 B1 to Lussey et al., which is hereby incorporated by reference in its entirety.

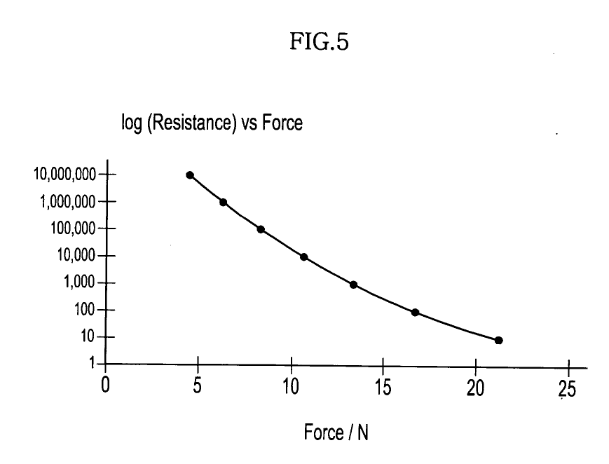

FIG. 5 is a graph showing the relationship between the force applied to the QTC 60 and the logarithm of its resistance. It can be seen from this graph that the logarithm of the resistance of the QTC 60 decreases as the force applied thereto increases. That is, the force applied to the QTC 60 is inversely proportional to its resistance.

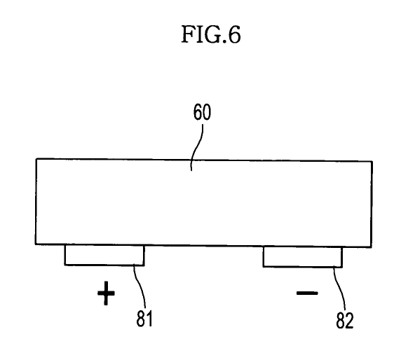

As shown in FIG. 6, a positive (+) electrode 81 and a negative (−) electrode 82 are formed on the QTC 60, and a specific voltage is applied across the positive and negative electrodes 81 and 82. When no pressure is applied to the QTC 60, no current flows through the QTC 60 since its resistance is very high as illustrated in FIG. 5.

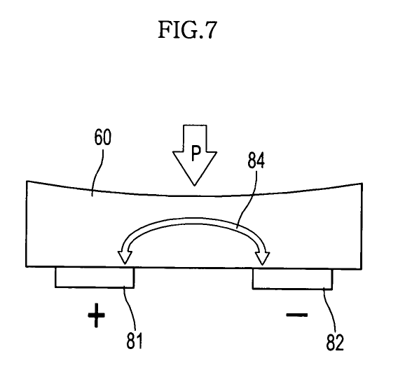

However, if a certain pressure P is applied to the QTC 60 with a voltage applied across the positive and negative electrodes 81 and 82 as illustrated in FIG. 7, the resistance of the QTC 60 changes in inverse proportion to the pressure P to form a conducting path 84 between the two electrodes 81 and 82, thereby permitting current flow through the QTC 60. The current flowing through the QTC 60 increases in proportion to the pressure P applied to the QTC 60.

In addition, the QTC 60 has a certain degree of rubber-like elasticity and thus has a resilient restoration property such that release of the pressure applied to the QTC 60 restores the deformed QTC 60 to its original state.

The operation of the zoom control unit will now be described with reference to FIG. 4.

Voltage has been applied to the terminal 65a connected to the bottom of the first QTC 60a. When no pressure is applied, no current flows through the first QTC 60a since its resistance is very high. However, when the T operation portion 50a is pressed to zoom in on a distant subject, the knob 50 rotates counterclockwise about the rotating shaft 56, so that the rotating knob 50 presses the first QTC 60a down. The resistance of the QTC 60a is reduced as it is pressed down, thereby causing current to flow through the first QTC 60a. The first current detector 71a, which is in contact with the first QTC 60a, detects the amount of current flowing through the first QTC 60a and changes the zoom speed in multiple steps. The harder the T operating portion 50a of the knob 50 is pressed, the more current flows through the first QTC 60a. The first current detector 71a increases the zoom speed as the current detected by the first current detector 71a increases. On the contrary, the first current detector 71a reduces the zoom speed if the force applied to press the T operating portion 50a of the knob 50 is reduced.

It is preferable that specific ranges of currents flowing through the first QTC 60a be set and the zoom speed change in multiple steps according to the set ranges in such a manner that the zoom speed changes when the detected current exceeds the upper limit or falls below the lower limit of a current range, such that the zoom speed is at a first level within the current range, at a second level within the next range, and so on. A description of the operation of the zoom control unit 20 when the W operation portion 50b is pressed is omitted since the zoom control unit 20 operates in the same manner as when the T operation portion 50a is pressed.

Using the QTCs 60a and 60b in the zoom control unit 20 in the above manner makes it easy to control the zoom speed depending on the force applied to press the knob 50.

As is apparent from the above description, an image capturing device having a zoom control unit according to the present invention does not use an elastic member such as a spring, thereby preventing malfunctions in the zoom control unit which occur due to changes in the elastic force of the elastic member.

In addition, the zoom control unit can be implemented with a small number of parts and can also be designed to be small, thereby reducing the manufacturing cost and size of the image capturing device.

Further, shaking of the image capturing device is minimal during manipulation of the zoom control unit since the zoom control unit is activated by depressing the switch.

While the invention has been shown and described with reference to certain embodiments thereof, it will be understood by those skilled in the art that various changes in form and details may be made therein without departing from the spirit and scope of the invention as defined by the appended claims.

What is claimed is:

1. An image capturing device having a zoom control unit comprising:
a case;
a holder provided inside the case;
a knob rotatably supported by the holder;
a plurality of quantum tunnelling composites (QTCs) housed in the holder, each of the QTCs changing in resistance according to pressure applied from the knob; and
a printed circuit board (PCB) including a plurality of current detectors mounted thereon to detect current flowing through the plurality of QTCs.

2. The image capturing device according to claim 1, wherein
the case has a manipulation hole, and
the knob has a portion exposed through the manipulation hole.

3. The image capturing device according to claim 1, wherein
voltage is applied across positive and negative electrodes formed on each of the QTCs.

4. The image capturing device according to claim 3, wherein
substantially no current flows through each of the QTCs when no pressure is applied to the QTC, and a resistance of the QTC gradually decreases and current flowing through the QTC gradually increases as pressure is applied to the QTC.

5. The image capturing device according to claim 4, wherein
each of the current detectors detects current flowing through a corresponding one of the QTCs and changes zoom speed in multiple steps according to the detected current.

6. The image capturing device according to claim 4, wherein
each of the QTCs has elasticity such that the QTC substantially restores an original state when the pressure applied to the QTC is released.

7. The image capturing device according to claim 1, wherein
a tele (T) operating portion to activate a T mode and a wide (W) operating portion to activate a W mode are provided on an upper surface of the knob, and a rotating shaft is integrally formed on the center of a lower surface of the knob so that the knob is rotatable.

8. The image capturing device according to claim 7, wherein
an end portion of a first one of the QTCs, which receives pressure when the T operating portion is pressed, is placed in a first receiving groove formed on the lower surface of the knob, and an end portion of a second one of the QTCs, which receives pressure when the W operating portion is pressed, is placed in a second receiving groove formed on the lower surface of the knob.

9. The image capturing device according to claim 7, wherein
a first rotating shaft receiving portion is formed at the center of the holder to receive the rotating shaft so that the rotating shaft is rotatably supported by the first rotating shaft receiving portion, and first and second receiving holes to respectively receive the first and second QTCs are formed on the holder about the first rotating shaft receiving portion.

10. The image capturing device according to claim 9, wherein
the first and second receiving holes are symmetrical with respect to the first rotating shaft receiving portion.

11. The image capturing device according to claim 9, wherein
the case includes a plurality of bosses formed thereon, each protruding down from the case to be coupled to the PCB and having a threaded hole defined therein,

12. The image capturing device according to claim 11, wherein
a second rotating shaft receiving portion is formed on the case, the second rotating shaft receiving portion being combined with the first rotating shaft receiving portion to prevent separation of the rotating shaft.

13. An image capturing device having a zoom control unit comprising:
a case;
a holder provided inside the case;
a knob rotatably supported by the holder, an upper portion of the knob having tele (T) and wide (W) operating portions;
first and second quantum tunnelling composites (QTCs), resistances thereof varying, respectively, according to changes of pressure applied to the tele (T) and wide (W) operating portions provided on the knob; and
first and second current detectors, connected respectively to the first and second QTCs, to detect current flowing through the first and second QTCs and to change zoom speed according to the detected current.

14. The image capturing device according to claim 14, wherein
the case has a manipulation hole, and
the knob has a portion exposed through the manipulation hole.

15. A zoom control unit for an image capturing device, comprising:
a first quantum tunnelling composite that has a resistance that varies proportionally with respect to pressure applied to the first quantum tunnelling composite;
a first current detector connected to the first quantum tunnelling composite, to detect current flowing through the first quantum tunnelling composite.
a second quantum tunnelling composite that has a resistance that varies proportionally with respect to pressure applied to the second quantum tunnelling composite;
a second current detector connected to the first quantum tunnelling composite, to detect current flowing through the second quantum tunnelling composite; and
a knob adapted to apply pressure to the first and second quantum tunnelling composites in response to a user activating the knob.

16. The zoom control unit for an image capturing device according to claim 15, wherein
substantially no current flows through each of the quantum tunnelling composites when no pressure is applied to the quantum tunnelling composite.

17. The zoom control unit for an image capturing device according to claim 16, wherein
the resistance of each of the quantum tunnelling composites gradually decreases and current flowing through the quantum tunnelling composite gradually increases as pressure is applied to the quantum tunnelling composite.

18. The zoom control unit for an image capturing device according to claim 15, wherein
a tele (T) operating portion and a wide (W) operating portion are provided on an upper surface of the knob.

19. The zoom control unit for an image capturing device according to claim 18, wherein
the knob has a rotating shaft integrally formed on a lower surface of the knob so that the knob is rotatable.

20. The zoom control unit for an image capturing device according to claim 18, wherein
the knob has first and second receiving grooves formed on the lower surface of the knob, and end portions of the first and second quantum tunnelling composites are placed in the first and second receiving grooves, respectively.
